(19) United States
(12) Patent Application Publication
(10) Pub. No.: US 2023/0357615 A1
(43) Pub. Date: Nov. 9, 2023

(54) Thermally Stable Filled Polyurethane Reactive Hot Melt

(71) Applicant: Henkel AG & Co. KGaA, Duesseldorf (DE)

(72) Inventors: Yingjie Li, Elgin, IL (US); Shuhui Qin, Elgin, IL (US)

(21) Appl. No.: 18/353,315

(22) Filed: Jul. 17, 2023

Related U.S. Application Data
(63) Continuation of application No. PCT/US2022/014201, filed on Jan. 28, 2022.
(60) Provisional application No. 63/145,197, filed on Feb. 3, 2021.

(51) Int. Cl. C09J 175/06; C09J 175/08; C09J 7/32; C09J 7/35; C08G 18/12; C08G 18/30; C08G 18/42; C08G 18/48; C08K 3/26; C08K 3/32; C08L 33/08

(52) U.S. Cl. CPC C09J 175/06; C09J 175/08; C09J 7/32; C09J 7/35; C08G 18/12; C08G 18/307; C08G 18/4238; C08G 18/4845; C08K 3/26; C08K 3/32; C08L 33/08; C09J 2301/304; C09J 2301/306; C09J 2301/408; C08K 2003/265; C08K 2003/329; C08L 2205/025

(57) ABSTRACT

Disclosed is a moisture reactive polyurethane hot melt adhesive composition prepared from a mixture comprising a polyisocyanate, a polyester polyol, a polyether polyol; a thermoplastic polymer; inorganic filler; optionally a MA-SCA acid; and optionally one or more additives; wherein the polyester polyol is polymerized from a diacid and a diol; wherein the structure of the diacid is HOOC—(CH₂)ₘ—COOH; wherein the structure of the diol is HO—(CH₂)ₙ—OH; wherein the sum of (m+n) is equal to or less than 8; and wherein the acid number of the polyester polyol is less than 0.9. The disclosed reactive hot melt adhesive composition has improved thermal stability compared to conventional moisture reactive polyurethane hot melt adhesive compositions while maintaining their desirable properties.

### TECHNICAL FIELD

This disclosure relates generally to reactive hot melt adhesives and more particularly to polyurethane hot melt adhesives having long open time, high green strength and improved thermal stability.

### BACKGROUND OF THE INVENTION

This section provides background information which is not necessarily prior art to the inventive concepts associated with the present disclosure.

Hot melt adhesives are solid at room temperature but, upon application of heat, they melt to a liquid or fluid state in which form they are applied to a substrate. On cooling, the adhesive regains its solid form. One class of hot melt adhesives are thermoplastic hot melt adhesives. Thermoplastic hot melt adhesives are generally thermoplastic and can be repeatedly heated to a fluid state and cooled to a solid state. Thermoplastic hot melt adhesives do not crosslink or cure; the hard phase(s) formed upon cooling the thermoplastic hot melt adhesive imparts all of the cohesion strength, toughness, creep and heat resistance to the final adhesive. Naturally, the thermoplastic nature limits the upper temperature at which such adhesives can be used.

Another class of hot melt adhesives are curable or reactive hot melt adhesives. Reactive hot melt adhesives start out as thermoplastic materials that can be repeatedly heated to a molten state and cooled to a solid state. However, when exposed to appropriate conditions, for example moisture, the reactive hot melt adhesive crosslinks and cures to an irreversible solid form. Reactive hot melt adhesives include moisture reactive polyurethane adhesives, moisture reactive organosilane adhesives; moisture reactive polysiloxane adhesives and moisture reactive silane polyolefin adhesives. The polyurethane hot melt adhesives comprise isocyanate terminated polyurethane prepolymers. Isocyanate terminated polyurethane prepolymers are conventionally obtained by reacting polyols with a molar excess of polyisocyanates. Isocyanate terminated polyurethane prepolymers cure by reaction of the terminal isocyanate groups in the prepolymer with moisture from the atmosphere or moisture on the substrates. This reaction results in a crosslinked material polymerized primarily through urea groups and urethane groups.

Reactive hot melt adhesives must be maintained at molten temperatures during use. However, even when kept under generally anhydrous conditions reactive hot melt adhesives will increase in viscosity while in a molten state. Eventually the adhesive viscosity becomes too high for the application equipment to handle, requiring shutdown of the hot melt adhesive application equipment and cleaning to remove the high viscosity hot melt adhesive. In very undesirable cases the molten reactive hot melt adhesive can gel or phase separate in application equipment while in use. This situation requires unplanned equipment shutdown, disassembly, cleaning and possibly replacement of parts that cannot be cleaned of the gelled hot melt adhesive. Naturally, excessive viscosity increases or phase separation of the reactive hot melt adhesive is considered undesirable and commercially unacceptable. Gelling is even less acceptable as the gelled material can be very difficult to remove from reaction or application equipment.

Unfilled polyurethane reactive hot melt adhesives are known to be thermally stable and can be maintained for use in the molten state for long periods of time. However, unfilled polyurethane reactive hot melt adhesives lack the performance, sustainability and economic properties of filled polyurethane reactive hot melt adhesives.

Fillers improve some performance parameters, sustainability and economics of a polyurethane reactive hot melt adhesives and are commonly included in such compositions. However, adding large amounts of fillers to a reactive hot melt adhesives will substantially increase the rate of viscosity rise of that composition in the molten state and substantially shorten the useful life of those adhesives. In worst cases the moisture reactive adhesives can gel or phase separate during use or even during preparation.

Reactive polyurethane hot melt adhesives find widespread use in panel lamination procedures. They provide good adhesion to a variety of materials and good cured bond strength. Their lack of a need for a solvent, green strength, and good resistance to heat, cold and a variety of chemicals make them ideal choices for use in the building industries. In particular they find use in recreation vehicle panel lamination and doors, applications that desire long open times and high green strength. Open time refers to the length of time after application of the molten hot melt adhesive during which a part can be bonded to the adhesive. A long open time is desirable in this application to allow time for parts in a complex composite structure to be added or repositioned. Green strength refers to the bond strength before curing. High green strength is desirable in this application as it allows bonded parts to be held together by the adhesive without further clamps or fasteners. Once the structure has been assembled a high green strength is desirable to allow the bonded structures to move to the next operation.

Highly filled polyurethane reactive hot melt adhesives prepared using polyester polyols optimized for stability do not provide the best green strength or open time. Highly filled polyurethane reactive hot melt adhesives prepared using polyester polyols optimized for open time and green strength do not provide the best thermal stability. It is challenging to formulate a highly filled polyurethane reactive hot melt having all of thermal stability, long open time and high green (initial) strength. It would be desirable to provide a thermally stable, highly filled polyurethane reactive hot melt adhesive that has long open time and high green (initial) strength. Such an adhesive would provide desirable improvements in performance, sustainability and economics. Conventional polyurethane hot melt adhesives have achieved some, but not all of, these advantages.

### SUMMARY OF THE DISCLOSURE

This section provides a general summary of the disclosure and is not a comprehensive disclosure of its full scope or all features, aspects or objectives.

In one embodiment the disclosure provides a moisture reactive hot melt adhesive composition prepared from a combination comprising a thermoplastic polymer; a polyisocyanate; an inorganic filler; a preferred polyester polyol; optionally a polyether polyol; optionally other polyester polyols; optionally an added MA-SCA acid; and optionally one or more additives. Preferably the preferred polyester polyol is polymerized from a diacid and a diol; wherein the structure of the diacid is HOOC—(CH₂)m-COOH and the structure of the diol is HO—(CH₂)n-OH; wherein the sum of (m+n) is equal to or less than 8; and the polyester polyol has an acid number of less than 0.9.

In one embodiment the polyester polyol has an acid number of 0.8 or less, or 0.7 or less, or 0.6 or less.

In one embodiment the polyester polyol has a number average molecular weight of from about 2,000 to about 11,000 and is present in an amount of from 10 to 35% by weight based on the total adhesive weight.

In one embodiment the polyester polyol is selected from polybutylene adipate diol, polyhexamethylene succinate diol, polybutylene succinate diol, polyethylene adipate diol, and polyethylene succinate diol.

In one embodiment the combination comprises a polyether polyol having a number average molecular weight of from 1,500 to 6,000 and the polyether polyol is present in an amount of from 15 to 40% by weight based on the total adhesive weight.

In one embodiment the polyether polyol is a polypropylene glycol.

In one embodiment the combination comprises a thermoplastic polymer which is an acrylic polymer having a weight average molecular weight of from 20,000 to 250,000 and/or the acrylic polymer is present in an amount of from 10 to 40% by weight based on the total adhesive weight.

In one embodiment the combination comprises a thermoplastic polymer which is an acrylic polymer having a glass transition temperature (Tg) of from 35to 85° C. and a hydroxyl number of less than 8.

In one embodiment the adhesive comprises about 10 to about 70%, or about 10 to about 50%, by weight based on the total adhesive weight; and/or the inorganic filler comprises calcium carbonate.

In one embodiment the hot melt adhesive composition further comprises one or more additives.

In one embodiment MA-SCA acid is present in an amount of less than 1000 ppm, less than 700 ppm, less than 400 ppm, less than 200 ppm based on weight of the hot melt adhesive composition and/or is an inorganic acid such as phosphoric acid.

In one embodiment the hot melt adhesive composition has long open times of greater than 3 minutes, preferably 4 to 10 minutes, more preferably 6 to 8 minutes; and/or high green strength of greater than 60 pounds per square inch (psi) within 30 minutes after application to a substrate; and/or high final cured mechanical strength of at least one of a yield strength of greater than or equal to 300 psi and/or a tensile strength of greater than or equal to 800 psi.

The disclosed compounds include any and all isomers and stereoisomers. In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in the prior art compositions or that are otherwise not necessary to the achievement of the function and/or objective of the present disclosure.

These and other features and advantages of this disclosure will become more apparent to those skilled in the art from the detailed description of a preferred embodiment. The drawings that accompany the detailed description are described below.

### BRIEF DESCRIPTION OF THE FIGURE

FIG. 1 is a chart showing the interaction between acid stabilizer and acid number of the polyester polyol and, more particularly, the effect of the MA-SCA acid and acid number of the polyester polyol on gelling and phase separation.

### DETAILED DESCRIPTION OF A PREFERRED EMBODIMENT

The singular forms “a”, “an” and “the” include plural referents unless the context clearly dictates otherwise.

About or “approximately” as used herein in connection with a numerical value refer to the numerical value ±10%, preferably ±5% and more preferably ±1% or less.

At least one, as used herein, means 1 or more, i.e., 1, 2, 3, 4, 5, 6, 7, 8, 9, or more. With reference to an ingredient, the indication refers to the type of ingredient and not to the absolute number of molecules. “At least one polymer” thus means, for example, at least one type of polymer, i.e., that one type of polymer or a mixture of several different polymers may be used.

The terms “comprising”, “comprises” and “comprised of” as used herein are synonymous with “including”, “includes”, “containing” or “contains”, and are inclusive or open-ended and do not exclude additional, non-recited members, elements or method steps.

“Free of”, as used in this context, means that the amount of the corresponding substance in the reaction mixture is less than 0.05 wt. %, preferably less than 0.01 wt. %, more preferably less than 0.001 wt. %, based on the total weight of the reaction mixture.

The term “preferred polyester polyols” as used herein refers to polyester polyols having the structure HO[—CH₂)ₙOOC(CH₂)ₘCOO—]ₐ—(CH₂)ₙ—OH, wherein such polyester polyols are manufactured by the following chemical reaction:

(a+1)HO—(CH₂)ₙ—OH+aHOOC—(CH₂)ₘCOOH↔

HO[—CH₂)ₙOOC(CH₂)ₘCOO—]ₐ—(CH₂)ₙ—OH+H₂O

wherein a is an integer and the sum of (m+n) is less than or equal to 8.

The term “acid number” as used herein refers to the number of carboxylic acid groups (—COOH groups) in a chemical compound, such as a polyester polyol. Acid number is determined by the amount of base required to neutralize the carboxylic acid groups. One useful test for determining the acid number of the polyester polyols of the inventive disclosure is ASTM D4662, Standard Test Methods of Polyurethane Raw Materials: Determination of Acid and Alkalinity Numbers of Polyols.

The term “green strength” herein generally refers to the strength developed within the first 30 minutes after application of the hot melt adhesive to a substrate.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

Preferred and preferably are used frequently herein to refer to embodiments of the disclosure that may afford particular benefits, under certain circumstances. However, the recitation of one or more preferable or preferred embodiments does not imply that other embodiments are not useful and is not intended to exclude those other embodiments from the scope of the disclosure.

Unless specifically noted, throughout the present specification and claims the term molecular weight when referring to a polymer refers to the polymer's number average molecular weight (Mn). The number average molecular weight Mₙ can be calculated based on end group analysis (OH numbers according to DIN EN ISO 4629, free NCO content according to EN ISO 11909) or can be determined by gel permeation chromatography according to DIN 55672 with THF as the eluent. If not stated otherwise, all given molecular weights are those determined by gel permeation chromatography.

“Room temperature” is 23° C. plus or minus 10° C.

The term “open time” refers to the time during which an adhesive can bond to a material.

Glass transition temperature (Tg) can be determined using known differential scanning calorimetry (DSC) methods, see for example ASTM E-1356 using DSC at a scanning rate of 10 C/min.

In one embodiment the disclosure provides a moisture reactive polyurethane hot melt adhesive composition prepared from a combination comprising polyisocyanate, preferred polyester polyol, thermoplastic polymer; and inorganic filler. The combination can optionally include one or more of MA-SCA acid; one or more polyether polyols; one or more different polyester polyols, which can be, but are not required to be, preferred polyester polyols; and one or more additives. The disclosed filled, polyurethane hot melt adhesives are thermally stable, have a desirably long open time and green strength and have improved performance, sustainability and economics.

### Polyisocyanate

Organic polyisocyanates that can be used include alkylene diisocyanates, cycloalkylene diisocyanates, aromatic diisocyanates and aliphatic-aromatic diisocyanates. Examples of isocyanates for use in the present disclosure include, by way of example and not limitation: methylenebisphenyldiisocyanate (MDI), isophorone diisocyanate (IPDI), hydrogenated methylenebisphenyldiisocyanate (HMDI), toluene diisocyanate (TDI), ethylene diisocyanate, ethylidene diisocyanate, propylene diisocyanate, butylene diisocyanate, trimethylene diisocyanate, hexamethylene diisocyanate, cyclopentylene-1,3-diisocyanate, cyclo-hexylene-1,4-diisocyanate, cyclohexylene-1,2-diisocyanate, 4,4′-diphenylmethane diisocyanate, 2,2-diphenylpropane-4,4′-diisocyanate, xylylene diisocyanate, 1,4-naphthylene diisocyanate, 1,5-naphthylene diisocyanate, m-phenylene diisocyanate, p-phenylene diisocyanate, diphenyl-4,4′-diisocyanate, azobenzene-4,4′-diisocyanate, diphenylsulphone-4,4′-diisocyanate, 2,4-tolylene diisocyanate, dichlorohexa-methylene diisocyanate, furfurylidene diisocyanate, 1-chlorobenzene-2,4-diisocyanate, 4,4′,4″-triisocyanatotriphenylmethane, 1,3,5-triisocyanato-benzene, 2,4,6-triisocyanato-toluene, 4,4′-dimethyldiphenyl-methane-2,2′,5,5-tetratetraisocyanate, and the like. While such compounds are commercially available, methods for synthesizing such compounds are well known in the art. Preferred isocyanate-containing compounds are isomers of methylenebisphenyldiisocyanate (MDI), isophorone diisocyanate (IPDI), hydrogenated MDI (HMDI) and toluene diisocyanate (TDI).

### Polyester Polyol

Although acid number of a polyester polyol may be one consideration of quality control when a manufacturer produces that polyester polyol, the maximal acid number limit is typically set at a fairly high level. Maximum acid number limits of 1.0, 2.0, and even 3.0 or higher have been found for polyester polyols from different manufacturers. In addition, most transporters, handlers and users of polyester polyols do not test for acid number and do not consider the potential increase in polyester polyol acid number associated with post-manufacturing processes such as transportation, storage, melting, and processing before it is reacted with polyisocyanate. These post-manufacturing processes have the potential to increase the polyester polyol acid number even further above the manufacturing limit.

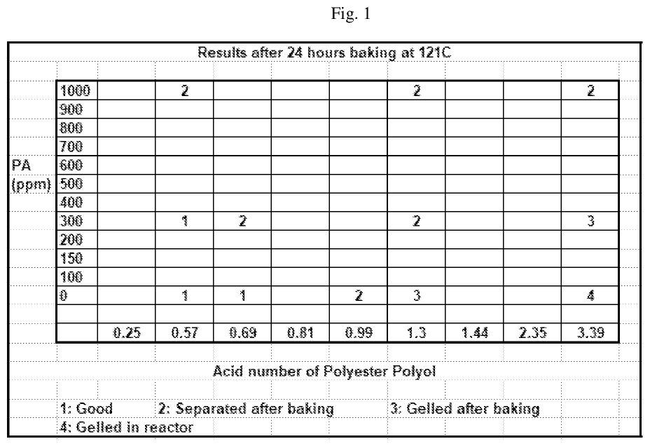

Surprisingly, the inventors have found that preferred polyester polyols with low acid numbers (less than 0.9 using ASTM D4662) improve many of the aforementioned undesirable issues and provide a thermally stable system. The inventors have also discovered that there is a surprising interaction between MA-SCA acid stabilizer and acid number of the preferred polyester polyol as shown in the chart in FIG. 1.

Preferred polyester polyols are the reaction product of a diacid of HOOC—(CH₂)ₘ—COOH and a diol HO—(CH₂)ₙ—OH with the sum of (m+n) equal to or less than 8. As used herein the sum of (m+n) will be an even integer such as 4, 6 or 8 wherein each of m and n is an even integer. Some of the examples of such polyester polyols are polybutylene adipate diol, polyhexamethylene succinate diol, polybutylene succinate diol, polyethylene adipate diol, and polyethylene succinate diol. For preferred polyester polyols with the sum of (m+n) equal to or less than 8, very desirable thermal stability can be obtained if the polyester polyol has an acid number less than 0.9, preferably less than 0.7, and most desirably less than 0.6. The preferred polyester polyols are preferably the reaction product of a diacid of HOOC—(CH₂)ₘ—COOH and a diol HO—(CH₂)ₙ—OH with the sum of (m+n) equal to 8. Surprisingly, when the sum of (m+n) is greater than 8, a variation of thermal stability is no longer the case and thermally stable systems can be obtained with polyester polyols having an acid number significantly greater than 0.9. (See Comparative Examples 15 and 19).

Not-preferred polyester polyols, those that do not fall within the preferred polyester polyol category, can be used in addition to the preferred polyester polyols. Combinations of different preferred polyester polyols, or non-preferred polyester polyols, or preferred polyester polyols and non-preferred polyester polyols can also be used.

### Polyether Polyol

Useful polyether polyols that can be used include linear and branched polyethers having hydroxyl groups. Examples of the polyether polyol may include a polyoxyalkylene polyol such as polyethylene glycol, polypropylene glycol, polybutylene glycol and the like. Further, a homopolymer and a copolymer of the polyoxyalkylene polyols may also be employed. Particularly preferable copolymers of the polyoxyalkylene polyols may include an adduct of at least one compound selected from the group ethylene glycol, propylene glycol, diethylene glycol, dipropylene glycol, triethylene glycol, 2-ethylhexanediol-1,3, glycerin, 1,2,6-hexane triol, trimethylol propane, trimethylol ethane, tris(hydroxyphenyl)propane, triethanolamine, triisopropanolamine, ethylenediamine and ethanolamine. Most preferably the polyether polyol comprises polypropylene glycol. Preferably the polyether polyol has a number average molecular weight of from 1,500 to 6,000 with a more preferred range of 2,000 to 4,000 Daltons. The polyether polyol may comprise a mixture of polyether polyols.

### Thermoplastic Polymer

The mixture includes one or more thermoplastic polymers. Preferred thermoplastic polymers include acrylic polymers. Acrylic polymers can be acrylic homopolymers or acrylic copolymers. Acrylic copolymers can be the reaction product of acrylate monomers, methacrylate monomers and mixtures thereof. Acrylic polymers can also be the reaction product of a non-acrylic monomer along with acrylate monomers, methacrylate monomers and mixtures thereof. In some embodiments acrylic polymers prepared from at least one of methyl methacrylate monomers and n-butyl methacrylic monomers are preferred. Examples of some preferred acrylic copolymers include Elvacite® 2013, which is a methyl methacrylate and n-butyl methacrylate copolymer having a weight average molecular weight of 34,000; Elvacite® 2016, which is a methyl methacrylate and n-butyl methacrylate copolymer having a weight average molecular weight of 60,000; and Elvacite® 4014 which is copolymer of methyl methacrylate, n-butyl methacrylate and hydroxyethyl methacrylate and has a weight average molecular weight of 60,000. The Elvacite® polymers are available from Lucite International. Other examples of acrylic polymers can be found in U.S. Pat. Nos. 6,465,104 and 5,021,507 herein incorporated by reference. The acrylic polymer may include active hydrogens or not. In some embodiments the acrylic polymer has a weight average molecular weight of from 20,000 to 250,000, preferably 25,000 to 200,000 and more preferably from 30,000 to 100,000. In some embodiments the acrylic polymer has an OH number of less than 8, more preferably less than 5. In some embodiments the acrylic polymer has a glass transition temperature Tg of from about 35 to about 85° C., preferably from 45 to 75° C. Combinations of different thermoplastic or acrylic polymers having different properties (functionality, Tg, molecular weight, OH number, etc.) can be used.

### Inorganic Filler

Fillers that can be used include inorganic materials, for example calcium carbonate, kaolin and dolomite. Calcium carbonate has been referred to as a non-fossil fuel based, sustainable, renewable material. Other examples of suitable fillers can be found in Handbook of Fillers, by George Wypych 3^{rd} Edition 2009 and Handbook of Fillers and Reinforcements for Plastics, by Harry Katz and John Milewski 1978. The inorganic filler is preferably present in an amount greater than 10% and more preferably greater than 20% based on the total adhesive weight. Prior attempts to utilize this amount of such fillers resulted in hot melt adhesives that have short open times and issues such as undesirable increase of the molten hot melt adhesive during use.

### MA-SCA Acid

An MA-SCA acid is a subset of multibasic acids having acidic groups connected eventually to a single central atom. Examples of MA-SCA acids include sulfuric acid, phosphonic acid, phosphoric acid, diphosphoric acid (pyrophosphoric acid). Acids which are not MA-SCA acids should not be used in the disclosed compositions. Examples of other acids which are not MA-SCA acids include hydrochloric acid, nitric acid, phosphinic acid, p-toluenesulfonic acid, ethanesulfonic acid, methanesulfonic acid, trifluoromethane sulfonic acid, acetic acid, propionic acid, fumaric acid, maleic acid, ethanedioic acid and adipic acid. Preferably, the composition includes an MA-SCA acid. Acids which are not MA-SCA acids should not be used as they do not provide the beneficial effects of MA-SCA acids and in fact can degrade thermal stability of the adhesive when used alone or in combination with MA-SCA acids.

The inventors have discovered that there is an interaction between MA-SCA acid and acid number of the preferred polyester polyol. Adding MA-SCA acid can retard viscosity rise and/or gelling behavior, either during use in the molten state or during formation of the adhesive in a reactor, but such additions can also interact with the polyester polyol to create phase separation at a certain point. As a change of added acid amount can quickly change the system between a gel and a phase separation, it is important that the added acid be added in a suitable amount to avoid phase separation.

### Additives

The adhesive formulation can optionally include, or be free of, one or more of a variety of conventional hot melt adhesive additives such as catalyst, organosilane, solvent, adhesion promoter, additional filler, plasticizer, colorant, rheology modifier, flame retardant, UV pigment, nanofiber, defoamer, compatible tackifier, curing catalyst, anti-oxidant, stabilizer, a thixotropic agent such as fumed silica, adhesion promoter and the like. Conventional additives that are compatible with the disclosed composition may simply be determined by combining a potential additive with the composition and determining if they are compatible. An additive is compatible if it is homogenous within the product at room temperature and at the use temperature. Conventional additives are known however some useful embodiments follow.

Catalysts that can optionally be used include, for example 2,2′-dimorpholinodiethylether, triethylenediamine, dibutyltin dilaurate and stannous octoate. A preferred catalyst is 2,2′-dimorpholinodiethylether.

Organosilanes that can be used include amino-silane such as a secondary amino-silane. One attractive silane includes at least two silyl groups, with three methoxy groups bond to each of the silanes hindered secondary amino group or any combination thereof. An example of one such commercially available amino-silane is bis-(trimethoxysilylpropyl)-amine, such as Silquest A-1170. Other examples of useful organosilanes include silanes having a hydroxy functionality, a mercapto functionality, or both, such as 3-aminopropyltrimethoxysilane, 3-aminopropyltriethoxysilane, 3-aminopropyltrismethoxy-ethoxyethoxysilane, 3-aminopropy 1-methy 1-diethoxysilane, N-methyl-3-aminopropyltrimethoxysilane, N-butyl-3-aminopropyltrimethoxysilane, 3-mercaptopropyltrimethoxysilane, 3-mercaptopropyltriethoxysilane, 3-mercaptopropyl-methyl-dimethoxysilane, (N-cyclohexylaminomethyl)methyldiethoxysilane, (N-cyclohexylaminomethyl) triethoxysilane, (N-phenylaminom-ethyl)methyldimethoxysilane, (N-phenylaminomethyl) tri-methoxysilane, N-ethyl-aminoisobutyltrimethoxysilane, 4-amino-3,3-dimethylbutyltrimethoxysilane, N-(n-butyl)-3-aminopropyltriethoxysilane, N-(n-butyl)-3-aminopropylalkoxydiethoxy-silane, bis(3-triethoxysilylpropyl)amine and any combination thereof.

Organosilanes are commercially available from many sources, for example Momentive Performance Materials (Silquest) and Evonik (Dynasylan). Some useful examples include Silquest Alink 15 (N-ethyl-3-trimethoxysilyl-2-methylpropanamine), Silquest Alink 35 (Gamma-isocyanatopropyltrimethoxysilane), Silquest A174NT (Gamma-methacryloxypropyltrimethoxysilane), Silquest A187 (Gamma-glycidoxypropyltrimethoxysilane), Silquest A189 (Gamma-mercaptopropyltrimethoxysilane), Silquest A 597 (Tris(3-(trimethoxysilyl)propyl)isocyanurate), Silquest A1110 (Gamma-aminopropyltrimethoxysilane), Silquest A1170 (Bis(trimethoxysilylpropyl)amine), Dynasylan 1189 (N-butyl-3-aminopropyltrimethoxysilane), Silquest A1289 (bis-(triethoxysilylpropyletrasulfide), and Silquest Y9669 (N-phenyl-gamma-aminopropyltrimethoxysilane).

Solvents include organic solvents. Aqueous solvents such as water will initiate curing so the adhesive formulation is preferably essentially free of any water. Preferably, the adhesive composition is essentially free from any solvents or water in any stage of the formulation.

No special reaction sequence is required to prepare the moisture reactive polyurethane hot melt adhesives. In one embodiment the disclosed hot melt adhesives can be prepared using the following procedure. Note that moisture must be excluded from the polyurethane reaction. The polyols are added to a reactor and placed under heat and vacuum to remove moisture. Once dried, polyisocyanate is added to the reactor which is maintained under heat and an inert gas barrier to exclude moisture. After reaction, the remaining components can be added to the reaction product and mixed in. Alternatively, the remaining components can be added to the polyols prior to or with the polyisocyanate. The final product is transferred to a moisture proof container and sealed immediately.

In one embodiment the hot melt adhesive comprises a reaction product of a mixture comprising:

| | | narrower range | preferred range |
|---|---|---|---|
| | range (wt. %) | (wt. %) | (wt. %) |
| polyisocyanate | 5-40 | 5-25 | 8-22 |
| preferred polyester polyol | 10-50 | 10-40 | 10-30 |
| polyester polyol¹ | 0-50 | 0-40 | 0-30 |
| polyether polyol | 0-40 | 10-35 | 15-30 |
| thermoplastic polymer | 1-50 | 10-40 | 15-35 |
| inorganic filler | 1-70 | 10-50 | 15-40 |
| MA-SCA acid | 0-5.0 | 0-2.5 | 0.005-1.0 |
| catalyst | 0-1 | 0.01-1 | 0.02-0.5 |
| organosilane | 0-10 | 0-5 | 0-2.5 |
| other additives | 0-50 | 0-35 | 0-25 |

¹these are non-preferred polyester polyols.

The disclosed hot melt adhesive is typically distributed and stored in its solid form and stored in the absence of moisture to prevent curing during storage. The hot melt adhesives are heated to a molten fluid form and maintained at high temperatures such as 121° C. or higher during use. In the absence of moisture, the molten hot melt adhesive must maintain an acceptable viscosity increase for 24 hours or more to avoid equipment shutdown. In some embodiments the disclosed hot melt adhesives have a viscosity increase (heat stability) of 1000% or less, more typically 500% or less, preferably 300% or less and more preferably 100% or less during use. Any gelling or separation into phases while the hot melt adhesive is in molten form is also objectionable and considered a failure of heat stability. Holding samples at 121° C. for 24 hours in a sealed container (e.g. excluding air and moisture) was used to approximate thermal stability under commercial conditions.

The invention also provides a method for bonding articles together which comprises providing the reactive hot melt adhesive at about room temperature in typically solid form; heating the reactive hot melt adhesive to a molten form; applying the molten reactive hot melt adhesive composition in molten form at a temperature in the range of from about 80° C. to about 145° C. to a first article; bringing a second article in contact with the molten composition applied to the first article; allowing the adhesive to cool and solidify; and subjecting the applied composition to conditions which will allow the composition to fully cure to a composition having an irreversible solid form. Solidification or setting occurs when the liquid melt begins to cool from its application temperature to room temperature. Curing of the composition to an irreversible solid form takes place over a period of 2 to 72 hours in the presence of ambient moisture available from the substrate surface or atmosphere and typically happens during and after solidification of the adhesive.

The hot melt adhesives according to the present disclosure can be applied in a variety of manners including by spraying, roller coating, extruding and as a bead. The disclosed hot melt adhesive can be prepared in a range of viscosities and is stable during storage as long as moisture is excluded. It can be applied to a range of substrates including metal, wood, plastic, glass and textile.

Thus, this disclosure includes reactive polyurethane hot melt adhesive compositions in both its uncured, solid form, as it is typically to be stored and distributed, its molten form after it has been melted just prior to its application and in its irreversibly solid form after curing.

The invention is further illustrated by the following non-limiting examples.

### EXAMPLES

The following components in Table 1 were utilized in the Examples that follow

TABLE 1

| Component | |
|---|---|
| PPG2000 | A polypropylene glycol, number average molecular |
| | weight of 2,000 from Covestro. |
| Thermoplastic | Elvacite ® 2016-a methyl methacrylate n-butyl methacrylate acrylic |
| Polymer | copolymer with a weight average molecular weight of 60,000, Tg of |
| | 55° C., from Lucite International. |
| filler | CaCO₃, from Imerys Pigments and Additives |
| ED | Ethane 1,2 diol |
| BD | 1,4 Butanediol |
| HD | 1,6 Hexanediol |
| SuA | Succinic acid |
| AA | Adipic acid |
| SA | Sebacic acid |
| Polyester polyol A | A series of BD/AA with a number average molecular weight of |
| | 5,000. m + n = 8. Each member had an acid number of 0.57, 0.69, |
| | 0.99, 1.30, 1.44 or 3.39 as noted. |
| Polyester polyol B | A series of BD/AA with a number average molecular weight of |
| | 3,500. m + n = 8. Each member had an acid number of 1.25 or 0.29. |
| Polyester polyol C | HD/AA, with a number average molecular weight of 3,500 and acid |
| | number = 1.12. m + n = 10. |
| Polyester polyol E | BD/SuA, having a number average molecular weight of 3,500 and |
| | acid number = 3.87. m + n = 6. |
| Polyester polyol F | ED/AA, with a number average molecular weight of 3,500 and acid |
| | number = 2.46. m + n = 6. |
| Polyester polyol G | HD/SuA, with a number average molecular weight of 3,500 and acid |
| | number = 1.28. m + n = 8. |
| Polyester polyol H | HD/SA with a number average molecular weight of 3,500 and acid |
| | number = 1.92. m + n = 14. |

TABLE 2
provides the generic formula for all the Examples.

| | Composition |
|---|---|
| Constituent | (Parts by Weight) |
| Polyether polyol (PPG2000) | 27.85 |
| Polyester polyol* | 14 |
| Elvacite 2016 | 19 |
| Calwhite (CaCO₃) (Imerys Pigments | 25 |
| and Additives Group) | |
| 4,4′-MDI | 14 |
| Additives** | <0.2 |

*See Table 1 for the polyesters used for examples.
**Such as 2,2′-dimorpholinildiethylether (DMDEE) catalyst, MA-SCA acid (phosphoric acid), or other additives as detailed in the examples that follow.

The initial or green strength can be measured using a cross peeler test. 0.8 grams of the adhesive was dispensed at 121° C. onto a hard wood strip and then mated to a second hard wood strip to create a 1 square inch cross section with adhesive coverage. Then after the indicated time points the tensile strength can be measured and recorded. As discussed above, the term green strength is the strength developed within the first 30 minutes after application of the hot melt adhesive to a substrate. Cured tensile strength can be measured using the same test procedure after the bonded sample has cured by exposure to room temperature and ambient moisture for 72 hours.

The open time can be measured as follows: 0.8 grams of the adhesive is dispensed at 121° C. onto a substrate and then a wooden tongue depressor is pressed against the adhesive and the time when no adhesive transfers to the tongue depressor is recorded while the adhesive cools to room temperature. An open time of 8 minutes means that for 8 minutes after being dispensed the adhesive could be transferred to or picked up by a tongue depressor pressed against the adhesive but not after 8 minutes.

Viscosity can be measured on a Brookfield DV-I+viscometer with a heated sample cup at 121° C. and using a #27 spindle after 30 minutes of sample equilibration in the sample cup at 121° C. Viscosity units are centipoise (cP).

TABLE 3 provides a summary of the results for all examples.

TABLE 3

| | | | | Polyester | | |
|---|---|---|---|---|---|---|
| | Original | Final | Viscosity | polyol (acid | Phosphoric | |
| Examples | viscosity | viscosity | Change (%) | number) | acid (ppm) | Index |
| Example 1 | 10,500 | 18,600 | 77.14 | A (0.57) | 0 | Inventive |
| Example 2 | 10,050 | 15,400 | 53.23 | A (0.57) | 300 | Inventive |
| Example 3 | 11,050 | Separation | — | A (0.57) | 1000 | Comparative |
| Example 4 | 15,200 | 48,200 | 217.11 | A (0.69) | 0 | Inventive |
| Example 5 | 11,900 | Separation | — | A (0.69) | 300 | Comparative |
| Example 6 | 14,800 | Separation | — | A (0.99) | 0 | Comparative |
| Example 7 | 17,550 | Gelation | — | A (1.30) | 0 | Comparative |
| Example 8 | 12,640 | Separation | — | A (1.30) | 300 | Comparative |
| Example 9 | 11,300 | Separation | — | A (1.30) | 1000 | Comparative |
| Example 10 | Gelation | — | — | A (3.39) | 0 | Comparative |
| Example 11 | 12,500 | Gelation | — | A (3.39) | 300 | Comparative |
| Example 12 | 15,300 | Separation | — | A (3.39) | 1000 | Comparative |
| Example 13 | 28,650 | Gelation | — | B (1.25) | 0 | Comparative |
| Example 14 | 11,650 | 22,000 | 88.84 | B (0.29) | 0 | Inventive |
| Example 15 | 11,900 | 20,300 | 70.59 | C (1.12) | 0 | Comparative |
| Example 16 | Gelation | — | — | E (3.87) | 0 | Comparative |
| Example 17 | Gelation | — | — | F (2.46) | 0 | Comparative |
| Example 18 | 20,000 | Separation/ | — | G (1.28) | 0 | Comparative |
| | | Gelation | | | | |
| Example 19 | 10,030 | 19,860 | 98.01 | H (1.92) | 0 | Comparative |
| Example 20 | 12,600 | 21,100 | 67.46 | A (1.44) | 0 | No filler, |
| | | | | | | Comparative |

FIG. 1 graphically illustrates some of the results from Table 3. The 24 hour bake at 250° F. approximates commercial time and temperatures of a hot melt adhesive in the molten state. FIG. 1 shows the surprising and complicated phase behavior of highly filled polyurethane hot melt adhesives. The X-axis is acid number of the preferred polyester polyol (polybutylene adipate diol) used in the adhesive and the Y-axis is the amount of MA-SCA acid (phosphoric acid or PA) in the adhesive. FIG. 1 shows the only desirable zone for highly filled polyurethane hot melt adhesives is in the lower left corner bounded by the “1” cells. The zone bounded by “2” cells illustrate compositions that may be useful but have an increased risk of phase separation during use in the molten state. The zone bounded by “3” cells illustrate compositions that can gel in application equipment during use in the molten state. The zone surrounding the “4” cell illustrates highly filled polyurethane hot melt adhesives that can gel as they are being formed and before they are ready for use. The “4” zone represents the most undesirable scenario where the system gelled during formation in the reactor, creating significant economic loss.

Examples were prepared as described below.

### EXAMPLE 1—Inventive

278.5 parts of PPG2000, were introduced into a heatable stirred tank reactor with a vacuum connection and 190 parts of Elvacite 2016, 140 parts of polyester polyol A (acid number=0.57), 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) were added and the contents of the reactor were stirred for 15 minutes under nitrogen at 121 C, and then 3 hours in vacuo at 121 C. The reactor was purged with nitrogen, 1.1 parts of 2,2′-dimorpholinildiethylether (DMDEE) were added and stirred for 15 minutes under nitrogen. The reaction product was then transferred to a moisture proof container and sealed immediately for later test.

### EXAMPLE 2—Inventive

278.5 parts of PPG2000, were introduced into a heatable stirred tank reactor with a vacuum connection and 190 parts of Elvacite 2016, 140 parts of polyester polyol A (acid number=0.57), 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) were added and the contents of the reactor were stirred for 15 minutes under nitrogen at 121 C, and then 3 hours in vacuo at 121 C. The reactor was purged with nitrogen, 1.1 parts of 2,2′-dimorpholinildiethylether (DMDEE) and 0.3 parts of phosphoric acid (85%) were added and stirred for 15 minutes under nitrogen. The reaction product was then transferred to a moisture proof container and sealed immediately for later test.

### EXAMPLE 3—Comparative

278.5 parts of PPG2000, were introduced into a heatable stirred tank reactor with a vacuum connection and 190 parts of Elvacite 2016, 140 parts of polyester polyol A (acid number=0.57), 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) were added and the contents of the reactor were stirred for 15 minutes under nitrogen at 121 C, and then 3 hours in vacuo at 121 C. The reactor was purged with nitrogen, 1.1 parts of 2,2′-dimorpholinildiethylether (DMDEE) and 1.0 parts of phosphoric acid (85%) were added and stirred for 15 minutes under nitrogen. The reaction product was then transferred to a moisture proof container and sealed immediately for later test.

### EXAMPLE 4—Inventive

278.5 parts of PPG2000, were introduced into a heatable stirred tank reactor with a vacuum connection and 190 parts of Elvacite 2016, 140 parts of polyester polyol A (acid number=0.69), 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) were added and the contents of the reactor were stirred for 15 minutes under nitrogen at 121 C, and then 3 hours in vacuo at 121 C. The reactor was purged with nitrogen, 1.1 parts of 2,2′-dimorpholinildiethylether (DMDEE) were added and stirred for 15 minutes under nitrogen. The reaction product was then transferred to a moisture proof container and sealed immediately for later test.

### EXAMPLE 5—Comparative

278.5 parts of PPG2000, were introduced into a heatable stirred tank reactor with a vacuum connection and 190 parts of Elvacite 2016, 140 parts of polyester polyol A (acid number=0.69), 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) were added and the contents of the reactor were stirred for 15 minutes under nitrogen at 121 C, and then 3 hours in vacuo at 121 C. The reactor was purged with nitrogen, 1.1 parts of 2,2′-dimorpholinildiethylether (DMDEE) and 0.3 parts of phosphoric acid (85%) were added and stirred for 15 minutes under nitrogen. The reaction product was then transferred to a moisture proof container and sealed immediately for later test.

### EXAMPLE 6—Comparative

278.5 parts of PPG2000, were introduced into a heatable stirred tank reactor with a vacuum connection and 190 parts of Elvacite 2016, 140 parts of polyester polyol A (acid number=0.99), 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) were added and the contents of the reactor were stirred for 15 minutes under nitrogen at 121 C, and then 3 hours in vacuo at 121 C. The reactor was purged with nitrogen, 1.1 parts of 2,2′-dimorpholinildiethylether (DMDEE) were added and stirred for 15 minutes under nitrogen. The reaction product was then transferred to a moisture proof container and sealed immediately for later test.

### EXAMPLE 7—Comparative

278.5 parts of PPG2000, were introduced into a heatable stirred tank reactor with a vacuum connection and 190 parts of Elvacite 2016, 140 parts of polyester polyol A (acid number=1.30), 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) were added and the contents of the reactor were stirred for 15 minutes under nitrogen at 121 C, and then 3 hours in vacuo at 121 C. The reactor was purged with nitrogen, 1.1 parts of 2,2′-dimorpholinildiethylether (DMDEE) were added and stirred for 15 minutes under nitrogen. The reaction product was then transferred to a moisture proof container and sealed immediately for later test.

### EXAMPLE 8—Comparative

278.5 parts of PPG2000, were introduced into a heatable stirred tank reactor with a vacuum connection and 190 parts of Elvacite 2016, 140 parts of polyester polyol A (acid number=1.30), 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) were added and the contents of the reactor were stirred for 15 minutes under nitrogen at 121 C, and then 3 hours in vacuo at 121 C. The reactor was purged with nitrogen, 1.1 parts of 2,2′-dimorpholinildiethylether (DMDEE) and 0.3 parts of phosphoric acid (85%) were added and stirred for 15 minutes under nitrogen. The reaction product was then transferred to a moisture proof container and sealed immediately for later test.

### EXAMPLE 9—Comparative

278.5 parts of PPG2000, were introduced into a heatable stirred tank reactor with a vacuum connection and 190 parts of Elvacite 2016, 140 parts of polyester polyol A (acid number=1.30), 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) were added and the contents of the reactor were stirred for 15 minutes under nitrogen at 121 C, and then 3 hours in vacuo at 121 C. The reactor was purged with nitrogen, 1.1 parts of 2,2′-dimorpholinildiethylether (DMDEE) and 1.0 parts of phosphoric acid (85%) were added and stirred for 15 minutes under nitrogen. The reaction product was then transferred to a moisture proof container and sealed immediately for later test.

### EXAMPLE 10—Comparative

278.5 parts of PPG2000, were introduced into a heatable stirred tank reactor with a vacuum connection and 190 parts of Elvacite 2016, 140 parts of polyester polyol A (acid number=3.39), 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) were added and the contents of the reactor were stirred for 15 minutes under nitrogen at 121 C, and then in vacuo at 121C. The mixture gelled in reactor in about 2 hours.

### EXAMPLE 11—Comparative

278.5 parts of PPG2000, were introduced into a heatable stirred tank reactor with a vacuum connection and 190 parts of Elvacite 2016, 140 parts of polyester polyol A (acid number=3.39), 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) and 0.3 parts of phosphoric acid (85%) were added and the contents of the reactor were stirred for 15 minutes under nitrogen at 121 C, and then 3 hours in vacuo at 121 C. The reactor was purged with nitrogen, 1.1 parts of 2,2′-dimorpholinildiethylether (DMDEE) were added and stirred for 15 minutes under nitrogen. The reaction product was then transferred to a moisture proof container and sealed immediately for later test.

### EXAMPLE 12—Comparative

278.5 parts of PPG2000, were introduced into a heatable stirred tank reactor with a vacuum connection and 190 parts of Elvacite 2016, 140 parts of polyester polyol A (acid number=3.39), 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) and 0.3 parts of phosphoric acid (85%) were added and the contents of the reactor were stirred for 15 minutes under nitrogen at 121 C, and then 3 hours in vacuo at 121 C. The reactor was purged with nitrogen, 1.1 parts of 2,2′-dimorpholinildiethylether (DMDEE) and 0.7 parts of phosphoric acid (85%) were added and stirred for 15 minutes under nitrogen. The reaction product was then transferred to a moisture proof container and sealed immediately for later test.

### EXAMPLE 13—Comparative

278.5 parts of PPG2000, were introduced into a heatable stirred tank reactor with a vacuum connection and 190 parts of Elvacite 2016, 140 parts of polyester polyol B (acid number=1.25), 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) were added and the contents of the reactor were stirred for 15 minutes under nitrogen at 121 C, and then 3 hours in vacuo at 121 C. The reactor was purged with nitrogen, 1.1 parts of 2,2′-dimorpholinildiethylether (DMDEE) were added and stirred for 15 minutes under nitrogen. The reaction product was then transferred to a moisture proof container and sealed immediately for later test.

### EXAMPLE 14—Inventive

278.5 parts of PPG2000, were introduced into a heatable stirred tank reactor with a vacuum connection and 190 parts of Elvacite 2016, 140 parts of polyester polyol B (acid number=0.29), 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) were added and the contents of the reactor were stirred for 15 minutes under nitrogen at 121 C, and then 3 hours in vacuo at 121 C. The reactor was purged with nitrogen, 1.1 parts of 2,2′-dimorpholinildiethylether (DMDEE) were added and stirred for 15 minutes under nitrogen. The reaction product was then transferred to a moisture proof container and sealed immediately for later test.

### EXAMPLE 15—Comparative

278.5 parts of PPG2000, were introduced into a heatable stirred tank reactor with a vacuum connection and 190 parts of Elvacite 2016, 140 parts of polyester polyol C, 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) were added and the contents of the reactor were stirred for 15 minutes under nitrogen at 121 C, and then 3 hours in vacuo at 121 C. The reactor was purged with nitrogen, 1.1 parts of 2,2′-dimorpholinildiethylether (DMDEE) were added and stirred for 15 minutes under nitrogen. The reaction product was then transferred to a moisture proof container and sealed immediately for later test.

### EXAMPLE 16—Comparative

278.5 parts of PPG2000, were introduced into a heatable stirred tank reactor with a vacuum connection and 190 parts of Elvacite 2016, 140 parts of polyester polyol E (acid number=3.87), 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) were added and the contents of the reactor were stirred for 15 minutes under nitrogen at 121 C, and then in vacuo at 121 C. The mixture gelled in reactor in about 1.5 hours.

### EXAMPLE 17—Comparative

278.5 parts of PPG2000, were introduced into a heatable stirred tank reactor with a vacuum connection and 190 parts of Elvacite 2016, 140 parts of polyester polyol F (acid number=2.46), 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) were added and the contents of the reactor were stirred for 15 minutes under nitrogen at 121 C, and then in vacuo at 121 C. The mixture gelled in reactor in about 2 hours.

### EXAMPLE 18—Comparative

278.5 parts of PPG2000, were introduced into a heatable stirred tank reactor with a vacuum connection and 190 parts of Elvacite 2016, 140 parts of polyester polyol G (acid number=1.28), 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) were added and the contents of the reactor were stirred for 15 minutes under nitrogen at 121 C, and then 3 hours in vacuo at 121 C. The reactor was purged with nitrogen, 1.1 parts of 2,2′-dimorpholinildiethylether (DMDEE) were added and stirred for 15 minutes under nitrogen. The reaction product was then transferred to a moisture proof container and sealed immediately for later test.

### EXAMPLE 19—Comparative

278.5 parts of PPG2000, were introduced into a heatable stirred tank reactor with a vacuum connection and 190 parts of Elvacite 2016, 140 parts of polyester polyol H, 250 parts of Calwhite, were blended and melted therein. Moisture was then removed in vacuo over a period of 1.5 hours at 121 C. The reactor was then purged with nitrogen, 140 parts of 4,4′-diphenylmethane-diisocyanate (MDI) were added and the contents of the reactor were stirred for 15 minutes under nitrogen at 121 C, and then 3 hours in vacuo at 121 C. The reactor was purged with nitrogen, 1.1 parts of 2,2′-dimorpholinildiethylether (DMDEE) were added and stirred for 15 minutes under nitrogen. The reaction product was then transferred to a moisture proof container and sealed immediately for later test.

### EXAMPLE 20—Comparative

278.5 parts of PPG2000, were introduced into a heatable stirred tank reactor with a vacuum connection and 190 parts of Elvacite 2016, 140 parts of polyester polyol A (acid number=1.44), were blended and melted therein. Moisture was then removed in vacuo over a period of 1.5 hours at 121 C. The reactor was then purged with nitrogen, 100 parts of 4,4′-diphenylmethane-diisocyanate (MDI) were added and the contents of the reactor were stirred for 15 minutes under nitrogen at 121 C, and then 3 hours in vacuo at 121 C. The reactor was purged with nitrogen, 1.1 parts of 2,2′-dimorpholinildiethylether (DMDEE) were added and stirred for 15 minutes under nitrogen. The reaction product was then transferred to a moisture proof container and sealed immediately for later test.

Unfilled polyurethane reactive hot melt adhesives are known and are thermally stable. See comparative Example 20. However, while such systems are thermally stable they do not offer the same improved performance, sustainability and economics as the disclosed compositions. Examples 15 and 19 illustrate filled polyurethane reactive hot melt adhesives with thermal stability formulated by using polyester polyols other than the preferred polyester polyols (m+n greater than 8), such as polyhexamethylene adipate diol. These hot melt adhesives are thermally stable, however, they do not offer optimal physical properties, such as open time and/or green strength, for some applications.

While the use of filler in a polyurethane hot melt adhesive can provide desirable performance, sustainability and economic advantages; it also creates thermal instability, leading to a need for stabilizing the filled polyurethane reactive hot melt system.

Adhesives made using preferred polyester polyols with an acid number below about 0.6 provide a filled polyurethane reactive hot melt adhesive having sustainability and economic properties as well as desirable long open time, high green strength, and thermal stability properties. As the acid number of the preferred polyester polyol used in the adhesive rises above 0.6, thermal stability starts to decrease, leading to undesirable viscosity rise, separation and even gelling in some applications. Addition of low amounts of an MA-SCA acid to adhesives made using preferred polyester polyols with an acid number of 0.9 or below will improve thermal stability of those adhesives. Surprisingly, this effect is less pronounced in adhesives made using low acid number preferred polyester polyols; and at some concentration the MA-SCA acid can be detrimental to thermal stability of that system. In adhesives made using preferred polyester polyols with higher acid numbers the thermal stability improvement is more pronounced and can change a gelling event to a phase separation event. While neither event is desirable, it is much easier to remove a phase separated adhesive from application equipment compared to a gelled adhesive. Further, the acid number of a polyester polyol can increase based on storage conditions and handling of that polyester polyol. Using a small amount of MA-SCA acid with the preferred polyols provides an extra assurance that thermal stability of the system will remain acceptable even if the acid number of the preferred polyester polyol changes due to storage or handling.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

We claim:

1. A moisture reactive polyurethane hot melt adhesive composition that is the product of a mixture comprising:
a reaction product of a mixture comprising a polyester polyol prepared from a diacid and a diol; wherein a structure of the diacid is HOOC—(CH₂)ₘ—COOH; a structure of the diol is HO—(CH₂)ₙ—OH; a sum of (m+n) is equal to or less than 8; and an acid number of the polyester polyol is less than 0.9, a polyisocyanate and optionally a polyether polyol;
an inorganic filler;
a thermoplastic polymer;
optionally a MA-SCA acid; polyether polyol, polyester polyol, and optionally one or more additives.

2. A reactive hot melt adhesive composition as recited in claim 1, wherein the acid number of the polyester polyol is less than 0.6.

3. A reactive hot melt adhesive composition as recited in claim 1, wherein the polyester polyol has a number average molecular weight of from about 2,000 to 11,000 and is present in an amount of from 10 to 35% by weight based on the total adhesive weight.

4. A reactive hot melt adhesive composition as recited in claim 1, wherein the polyester polyol is selected from the group consisting of polybutylene adipate diol, polyhexamethylene succinate diol, polybutylene succinate diol, polyethylene adipate diol, and polyethylene succinate diol.

5. A reactive hot melt adhesive composition as recited in claim 1, wherein the polyether polyol comprises polyether glycol.

6. A reactive hot melt adhesive composition as recited in claim 1, wherein the thermoplastic polymer is an acrylic polymer having a weight average molecular weight of from 20,000 to 250,000 and is present in an amount of from about 10 to 40% by weight based on the total adhesive weight.

7. A reactive hot melt adhesive composition as recited in claim 1, wherein the thermoplastic polymer comprises two or more acrylic polymers, each having a different weight average molecular weight in the range of 20,000 to 250,000.

8. A reactive hot melt adhesive composition as recited in claim 1, wherein the thermoplastic polymer is an acrylic polymer having a glass transition temperature of from 35 to 85° C. and a hydroxyl number of less than 8.

9. A reactive hot melt adhesive composition as recited in claim 1, wherein the polyisocyanate is present in an amount of from about 5 to 40% by weight based on the total adhesive weight; and/or the polyisocyanate comprises 4,4′-methylenebisphenyldiisocyanate (MDI).

10. A reactive hot melt adhesive composition as recited in claim 1, wherein the filler is present in an amount of from about 10% to about 70%, by weight based on the total adhesive weight.

11. A reactive hot melt adhesive composition as recited in claim 1, wherein the filler comprises calcium carbonate.

12. A reactive hot melt adhesive composition as recited in claim 1, further comprising an additive selected from catalyst, organosilane, solvent, adhesion promoter, additional filler, plasticizer, colorant, rheology modifier, flame retardant, UV pigment, nanofiber, defoamer, compatible tackifier, curing catalyst, anti-oxidant, stabilizer, a thixotropic agent such as fumed silica, adhesion promoter and mixtures thereof.

13. A reactive hot melt adhesive composition as recited in claim 1, wherein a MA-SCA acid is present in an amount of less than 1000 ppm.

14. A reactive hot melt adhesive composition as recited in claim 1, wherein the MA-SCA acid is present in the composition and is phosphoric acid.

15. A reactive hot melt adhesive composition as recited in claim 1, further comprising 2,2′-dimorpholinildiethylether (DMDEE).

16. An article of manufacture comprising the reactive hot melt adhesive composition according to claim 1.

17. A method of bonding two substrates together comprising applying the reactive hot melt adhesive according to claim 1 in molten form to a first substrate and then bringing a second substrate into contact with the adhesive on the first substrate and allowing the adhesive to cool and cure to an irreversible solid form.

18. Cured reaction products of the hot melt adhesive composition according to claim 1.
